(19) United States
(12) Patent Application Publication
(10) Pub. No.: US 2017/0113790 A1
(43) Pub. Date: Apr. 27, 2017

(54) FAIRING WITH INTEGRATED SENSORY SYSTEM OF A ROTARY-WING AIRCRAFT

(71) Applicant: Sikorsky Aircraft Corporation, Stratford, CT (US)

(72) Inventors: Daniel Bazzani, Jupiter, FL (US); Erez Eller, Oakville, CT (US); Peter J. Germanowski, Newtown, CT (US)

(21) Appl. No.: 15/296,677

(22) Filed: Oct. 18, 2016

Related U.S. Application Data
(60) Provisional application No. 62/244,255, filed on Oct. 21, 2015.

(51) Int. Cl. B64C 27/10; B64C 7/00; G01S 17/02; G06T 11/60; G01S 13/02; B64D 47/08; B64C 11/30

(52) U.S. Cl. CPC B64C 27/10; B64D 47/08; B64C 7/00; B64C 11/308; G06T 11/60; G01S 13/02; G01S 17/02; B64C 27/14

(57) ABSTRACT

A rotary-wing aircraft includes an airframe, a first rotor assembly configured to rotate about an axis and a first fairing disposed between the airframe and the first rotor assembly. A sensory system of the rotary-wing aircraft is supported by the first fairing.

### CROSS-REFERENCE TO RELATED APPLICATION

This application claims the benefit of U.S. provisional patent application Ser. No. 62/244,255 filed Oct. 21, 2015, the entire contents of which are incorporated herein by reference.

BACKGROUND

The present disclosure relates to a rotary-wing aircraft, and more particularly, to a rotary-wing aircraft having a sensory system.

For rotary-wing aircraft, sensory or weapon systems such as a Forward Looking Infrared/Laser Range Finder system and/or radar sensor system, are typically mounted above the rotor(s). This placement provides the ability for the aircraft to observe and interrogate targets over a terrain or structure. Such placement also assists in reducing the aircraft visibility and infrared signature. Unfortunately, positioning the sensory system above the rotor(s) adds additional drag to the aircraft and may be difficult to package.

### SUMMARY

A rotary-wing aircraft according to one, non-limiting, embodiment of the present disclosure includes an airframe; a first rotor assembly configured to rotate about an axis; a first fairing disposed between the airframe and the first rotor assembly; and a sensory system supported by the first fairing.

Additionally to the foregoing embodiment, a second rotor assembly disposed between the first fairing and the airframe.

In the alternative or additionally thereto, in the foregoing embodiment, the rotary-wing aircraft includes a rotor hub fairing associated with the first rotor assembly, and wherein the first fairing is a shaft fairing.

In the alternative or additionally thereto, in the foregoing embodiment, the first fairing is rigidly engaged to the airframe.

In the alternative or additionally thereto, in the foregoing embodiment, the rotary-wing aircraft includes a first shaft associated with the first rotor assembly and a second shaft associated with the second rotor assembly, wherein the first and second shafts are configured to rotate about the axis; a first bearing carried between the first shaft and the first fairing; and a second bearing carried between the second shaft and the first fairing.

In the alternative or additionally thereto, in the foregoing embodiment, the first and second shafts are counter rotating.

In the alternative or additionally thereto, in the foregoing embodiment, the rotary-wing aircraft includes an upper rotor hub fairing associated with the first rotor assembly; and a lower hub fairing associated with the second rotor assembly, and wherein the first fairing is located axially between the upper and lower hub fairings.

In the alternative or additionally thereto, in the foregoing embodiment, the first fairing is substantially stationary with respect to the airframe.

In the alternative or additionally thereto, in the foregoing embodiment, the rotary-wing aircraft includes a de-rotation device supported by at least one of the first and second rotor assemblies and configured to control circumferential positioning of the first fairing.

In the alternative or additionally thereto, in the foregoing embodiment, the sensory system is an optical system configured for observation reconnaissance.

In the alternative or additionally thereto, in the foregoing embodiment, the sensory system is configured to perform at least one of target interrogation and range finding to support deployment of weaponry.

In the alternative or additionally thereto, in the foregoing embodiment, the sensory system includes at least one of a FLIR/LRF system and a radar sensor system.

In the alternative or additionally thereto, in the foregoing embodiment, the sensory system includes a gimbal mechanism integrated into the first fairing.

In the alternative or additionally thereto, in the foregoing embodiment, the sensory system includes a generator supported by the first fairing and configured to generate power utilizing one of the first and second shafts for energizing the sensory system.

In the alternative or additionally thereto, in the foregoing embodiment, the sensory system includes a transceiver configured to transfer wireless signals between the sensory system and the airframe.

In the alternative or additionally thereto, in the foregoing embodiment, the first fairing is aerodynamic and the sensory system includes a transparent cover conforming to the contours of the first fairing and a camera located behind the transparent cover.

A dual, coaxial, rotor system for a rotary-wing aircraft according to another, non-limiting, embodiment includes an upper rotor assembly configured to rotate about an axis and including an upper hub and a plurality of rotor blades projecting radially outward from the upper hub; a lower rotor assembly spaced axially from the upper rotor assembly, configured to rotate about the axis and including a lower hub and a plurality of rotor blades projecting radially outward from the lower hub; an upper fairing constructed to cover the upper hub; a lower fairing constructed to cover the lower hub; a shaft fairing located axially between the upper and lower fairings, and wherein the shaft fairing is substantially stationary with respect to the airframe; and a sensory system supported by the shaft fairing.

Additionally to the foregoing embodiment, the upper and lower fairings are counter rotating with respect to one-another.

A method of operating a sensory system positioned in a shaft fairing of a dual, coaxial, rotor system of a rotary-wing aircraft according to another, non-limiting, embodiment includes initiating imaging via a device mounted to the shaft fairing; and applying software-based image processing logic to filter blade passage of upper and lower rotor assemblies.

Additionally to the foregoing embodiment, the method includes applying sensor stitching technology when a plurality of images from a plurality of devices mounted to the shaft fairing are initiated.

The foregoing features and elements may be combined in various combinations without exclusivity, unless expressly indicated otherwise. These features and elements as well as the operation thereof will become more apparent in light of the following description and the accompanying drawings. However, it should be understood that the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1 is a side view of a rotary-wing aircraft as a, non-limiting, exemplary embodiment of the present disclosure;

FIG. 2 is a cross section of the rotary-wing aircraft; and

FIG. 3 is a partial, enlarged, cross section of the rotary-wing aircraft illustrating a sensory system.

### DETAILED DESCRIPTION

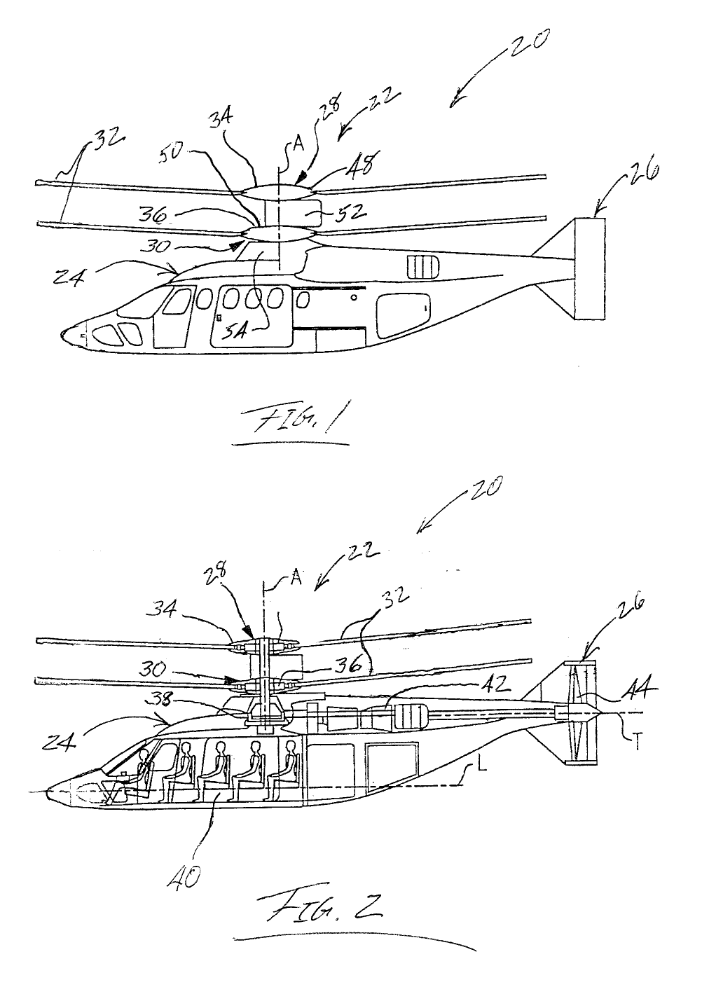

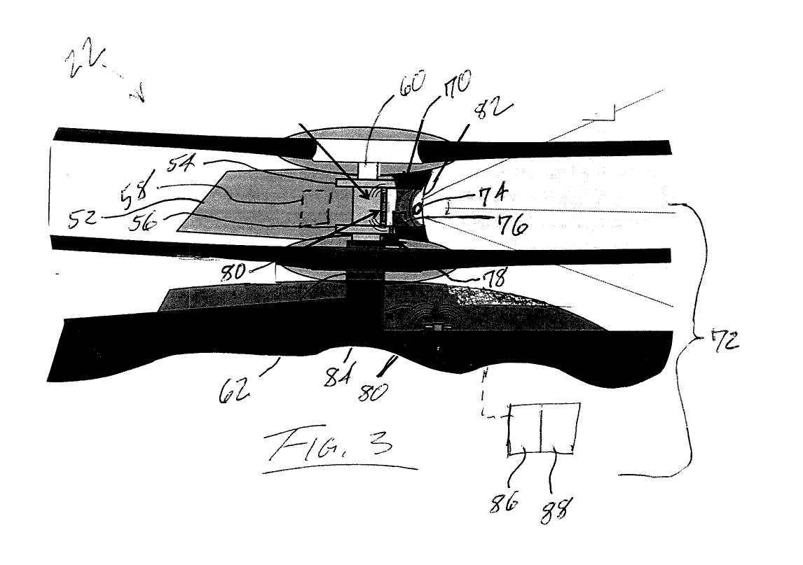

Referring to FIGS. 1 and 2, an exemplary vertical takeoff and landing (VTOL) rotary-wing aircraft 20 is illustrated. The rotary-wing aircraft 20 includes a rotor system 22 that rotates about a rotational axis A, an airframe 24 and an optional translational thrust system 26. The rotor system 22 may be a dual, counter-rotating, coaxial rotor system, and is supported by the airframe 24. The translational thrust system 26 provides translational thrust generally parallel to a longitudinal axis L of the rotary-wing aircraft 20. Although a particular aircraft configuration is illustrated in the disclosed embodiment, other rotary-wing aircraft will also benefit from the present disclosure.

The rotor system 22 may include an upper rotor assembly 28 and a lower rotor assembly 30. Each rotor assembly 28, 30 includes a plurality of rotor blades 32 mounted to respective rotor hubs 34, 36 for rotation about axis A. The rotor blades 32 project substantially radially outward from the hubs 34, 36, are circumferentially spaced from one-another, and are connected thereto in any manner known to one of ordinary skill in the art. Any number of rotor blades 32 may be applied to the rotor system 22.

A main gearbox 38 adapted to drive the rotor system 22 may be generally supported by and located in the airframe 24 and above an aircraft cabin 40 of the airframe. The translational thrust system 26 may also be driven by the same main gearbox 38. The main gearbox 38 may be driven by one or more engines 42 that may be gas turbine engines. Generally, the main gearbox 38 may be interposed between the engine(s) 42, the rotor system 22 and the translational thrust system 26.

The translational thrust system 26 may be adapted to provide thrust for high-speed flight, and may include a pusher propeller 44 mounted within an aerodynamic cowling 46 of the thrust system. The translational thrust system 26 may be mounted to the rear of the airframe 24, with the propeller 44 configured to rotate about an axis T that is orientated substantially horizontal and parallel to the aircraft longitudinal axis L.

The rotor system 22 may further include an upper rotor hub fairing 48, a lower rotor hub fairing 50 and a shaft fairing 52 that may be located between the upper and lower fairings 48, 50. The fairings 48, 50, 52, together, achieve a significant drag reduction in which large-scale flow separation is greatly reduced. To reduce interference effects between fairings and eliminate excess separation in the junction areas, the shaft fairing 52 may generally follow the contours of the upper and lower hub fairings 48, 50. Furthermore, the lower hub fairing 48 may generally follow the contours of the airframe 24 in an area typically referred to on a rotary-wing aircraft as a pylon 54. It is further contemplated and understood that any variety and configurations of fairings may be applicable to the present disclosure and benefit therefrom. For a further understanding of other aspects of the rotor hub fairings 48, 50, 52 and associated components thereof, attention is directed to U.S. Pat. No. 7,229,251, filed May 31, 2005, assigned to the assignee of the present disclosure and is hereby incorporated by reference in its entirety.

Referring to FIG. 3, the counter-rotating, coaxial rotor system 22 may further include an upper bearing 54, a lower bearing 56, and a de-rotation device 58. The upper and lower bearings 54, 56 may be located adjacent to respective upper and lower portions of the shaft fairing 52. The upper bearing 54 may be attached to one rotor shaft 60 and the lower bearing 56 may be attached to the other rotor shaft 62. Because the shafts 60, 62 are counter rotating, thus the bearings 54, 56 are counter rotating with respect to one-another, the net bearing drag is relatively low. With a relatively low net bearing drag, the shaft fairing 52 may be generally positioned at a relative angular position about the rotational axis A and relative to the airframe 24.

The de-rotation device 58 prevents misalignment of the shaft fairing 52 and may further control the position of the shaft fairing 52. The de-rotation device 58 is supported by at least one of the upper and lower rotor assemblies 28, 30. For a further understanding of at least one embodiment of a de-rotation device 58, attention is directed to Patent Application PCT/US2006/020349, filed May 23, 2006 with a Priority Date of May 26, 2005, with a Publication Date of Feb. 15, 2011, assigned to the assignee of the present disclosure, and is hereby incorporated by reference in its entirety.

The rotary-wing aircraft 20 further includes a sensory system 70 that is supported and generally housed by the shaft fairing 52. The sensory system 70 may be at least a part of a Forward Looking Infrared/Laser Range Finder (FLIR/LRF) system 72. The sensory system 70 is generally mounted in the shaft fairing 52 and between the upper and lower rotor hub fairings 48, 50 to provide the ability for the aircraft 20 to observe and interrogate targets on, for example, a battlefield while hovering behind the safety of cover such as, for example, a terrain or structure. The sensory system 70 may further be used to support deployment of weaponry. Moreover, the location of the sensory system 70 within the aerodynamically shaped fairing 52 eliminates any aerodynamic drag produced by the more traditional locations of such sensory systems. It is further contemplated and understood that the sensory system 70 may be any type of optical systems, radar systems, and/or camera orientated systems (e.g., FLIR Camera, video camera, etc.) and other devices.

The sensory system 70 may include a device 74 that may be a detection device, a gimbal mechanism 76, a power generator 78, and a remote transceiver 80 and a transparent cover 82. The device 74 may be an FLIR camera, a video camera, a laser device, or any other variety of detection devices. The gimbal mechanism 76 is configured to move the device 74 toward desired targets generally independent of the shaft fairing 52 motion with respect to the airframe 24, and may be remotely operated from the cockpit of the cabin 40. Alternatively, or in addition thereto, the gimbal mechanism 76 may be configured to stabilize the device 74 or otherwise correct the device positioning as a result of shaft fairing 52 and/or airframe 24 motion.

The power generator 78 may be configured to generate electrical energy from the rotation of either shaft 60, 62 to power the device 74, the gimbal mechanism 76, the remote transceiver 80 and other electrical components of the sensory system 70. The transparent cover 82 may be position in front of the device 74 to protect the device from debris and the forces produced by air movement. The cover 82 may be contoured and generally flush with the shaft fairing 52 to substantially eliminate any additional drag. It is further contemplated and understood that if electric motor-generators (not shown) are used as part of the de-rotation device 58 to control shaft fairing 52 positioning, the same motor-generators may be used as the generator 78 to power the sensory system 70.

The remote transceiver 80 may communicate directly with the device 74 and the gimbal mechanism 76. To avoid the use of slip rings, the remote transceiver 80 may further include wireless communication capability for sending communication and control signals 84 between the cockpit and the sensory system 70. The FLIR/LRF system and/or radar system 72 may further include a local transceiver 82 engaged to the airframe 24 and generally proximate to the shaft fairing 52 for receiving and sending the wireless signals 84 as part of a local wireless high speed encrypted network and/or short range network. Communication and control with the cockpit may be hard-wired to the local transceiver 82. It is further contemplated and understood that communications between the cockpit and the sensory system 70 may be achieved through radio frequencies (RF), optical communications, inductive communications, and others.

The FLIR/LRF system and/or radar system 72 may further include an electronic processor 86 and a computer readable storage media 88 for loading and processing of software. The software may include image processing logic that may be utilized to filter blade 32 passage of the upper and lower rotor assemblies 28, 30 from an FLIR image. It is further contemplated and understood that a sensory system 70 with multiple detection or image devices 74 (e.g., FUR sensors), may apply ‘sensor stitching’ technology for improved field awareness (e.g., battlefield awareness). In an example where the device 75 is a laser, the laser may be synchronized to fire between blade passage in order to prevent unwanted laser refection off of the rotor assemblies 28, 30.

It is further contemplated and understood that the sensory system 70 may generally be mounted to an intermediate stand pipe (not shown) that may be rigidly engaged to the airframe 24. In this example, the sensor system 70 may still be positioned between the upper and lower rotor assemblies 28, 30. Moreover, if a shaft fairing 52 is utilized, the sensor system 70 may be located within the fairing, and the fairing may be rigidly mounted to the standpipe fixed to the airframe 24. With use of a stand pipe, communication between the sensory system 70 and the cockpit may be directly hard-wired without use of wireless communication or the need for the remote and local transceivers 80, 82. It is further contemplated and understood that use of a system with a standpipe may further include wireless communications as, for example, a backup system.

While the present disclosure is described with reference to exemplary embodiments, it will be understood by those skilled in the art that various changes may be made and equivalents may be substituted without departing from the spirit and scope of the present disclosure. In addition, various modifications may be applied to adapt the teachings of the present disclosure to particular situations, applications, and/or materials, without departing from the essential scope thereof. The present disclosure is thus not limited to the particular examples disclosed herein, but includes all embodiments falling within the scope of the appended claims.

What is claimed is:

1. A rotary-wing aircraft comprising:
an airframe;
a first rotor assembly configured to rotate about an axis;
a first fairing disposed between the airframe and the first rotor assembly; and
a sensory system supported by the first fairing.

2. The rotary-wing aircraft set forth in claim 1 further comprising:
a second rotor assembly disposed between the first fairing and the airframe.

3. The rotary-wing aircraft set forth in in claim 1 further comprising:
a rotor hub fairing associated with the first rotor assembly, and wherein the first fairing is a shaft fairing.

4. The rotary-wing aircraft set forth in claim 1, wherein the first fairing is rigidly engaged to the airframe.

5. The rotary-wing aircraft set forth in claim 2 further comprising:
a first shaft associated with the first rotor assembly and a second shaft associated with the second rotor assembly, wherein the first and second shafts are configured to rotate about the axis;
a first bearing carried between the first shaft and the first fairing; and
a second bearing carried between the second shaft and the first fairing.

6. The rotary-wing aircraft set forth in claim 5, wherein the first and second shafts are counter rotating.

7. The rotary-wing aircraft set forth in claim 2, further comprising:
an upper rotor hub fairing associated with the first rotor assembly; and
a lower hub fairing associated with the second rotor assembly, and wherein the first fairing is located axially between the upper and lower hub fairings.

8. The rotary-wing aircraft set forth in claim 1, wherein the first fairing is substantially stationary with respect to the airframe.

9. The rotary-wing aircraft set forth in claim 2, further comprising:
a de-rotation device supported by at least one of the first and second rotor assemblies and configured to control circumferential positioning of the first fairing.

10. The rotary-wing aircraft set forth in claim 1, wherein the sensory system is an optical system configured for observation reconnaissance.

11. The rotary-wing aircraft set forth in claim 1, wherein the sensory system is configured to perform at least one of target interrogation and range finding to support deployment of weaponry.

12. The rotary-wing aircraft set forth in claim 1, wherein the sensory system includes at least one of a FLIR/LRF system and a radar sensor system.

13. The rotary-wing aircraft set forth in claim 1, wherein the sensory system includes a gimbal mechanism integrated into the first fairing.

14. The rotary-wing aircraft set forth in claim 5, wherein the sensory system includes a generator supported by the first fairing and configured to generate power utilizing one of the first and second shafts for energizing the sensory system.

15. The rotary-wing aircraft set forth in claim 1, wherein the sensory system includes a transceiver configured to transfer wireless signals between the sensory system and the airframe.

16. The rotary-wing aircraft set forth in claim 1, wherein the first fairing is aerodynamic and the sensory system includes a transparent cover conforming to the contours of the first fairing and a camera located behind the transparent cover.

17. A dual, coaxial, rotor system for a rotary-wing aircraft comprises:
an upper rotor assembly configured to rotate about an axis and including an upper hub and a plurality of rotor blades projecting radially outward from the upper hub;
a lower rotor assembly spaced axially from the upper rotor assembly, configured to rotate about the axis and including a lower hub and a plurality of rotor blades projecting radially outward from the lower hub;
an upper fairing constructed to cover the upper hub;
a lower fairing constructed to cover the lower hub;
a shaft fairing located axially between the upper and lower fairings, and wherein the shaft fairing is substantially stationary with respect to the airframe; and
a sensory system supported by the shaft fairing.

18. The dual, coaxial, rotor system set forth in claim 17, wherein the upper and lower fairings are counter rotating with respect to one-another.

19. A method of operating a sensory system positioned in a shaft fairing of a dual, coaxial, rotor system of a rotary-wing aircraft comprising:
initiating imaging via a device mounted to the shaft fairing; and
applying software-based image processing logic to filter blade passage of upper and lower rotor assemblies.

20. The method set forth in claim 19 further comprising:
applying sensor stitching technology when a plurality of images from a plurality of devices mounted to the shaft fairing are initiated.
